(19) United States
(12) Patent Application Publication
(10) Pub. No.: US 2007/0015616 A1
(43) Pub. Date: Jan. 18, 2007

(54) Power transmission assembly for an agricultural machine

(76) Inventors: Joseph A. Teijido, East Moline, IL (US); Robert W. Hawkins, Rapids City, IL (US); Jeffery A. Turigliatti, Geneseo, IL (US); Lukus John Leander, Orion, IL (US); Eric Lee Bortner, Moline, IL (US); Jeffrey Lee Wigand, Moline, IL (US); Steve Michael Juhasz, Moline, IL (US); Roy David Hansen, Moline, IL (US)

Correspondence Address: DEERE & COMPANY, ONE JOHN DEERE PLACE, MOLINE, IL, 61265, US

(21) Appl. No.: 11/179,833

(22) Filed: Jul. 12, 2005

(51) Int. Cl. F16H 61/00; F16H 59/00; F16H 63/00

(52) U.S. Cl. 474/19; 474/17; 474/8

(57) ABSTRACT

A power transmission assembly for an agricultural machine includes a gearbox having an input shaft, and a torque sensing assembly having an axially fixed sheave, an axially movable sheave, a cam assembly interposed between the axially fixed sheave and the axially movable sheave, and a spring assembly coupling the axially movable sheave to the axially fixed sheave. The axially fixed sheave includes a hub portion having a tapered face extending increasingly outward from an inside diameter to engage a beveled shoulder of the input shaft. A nut is engaged with a threaded end of the input shaft, such that when tightened the nut forces the tapered face of the axially fixed sheave into engagement with the beveled shoulder of the input shaft.

### FIELD OF THE INVENTION

The present invention is directed to an agricultural machine, and, more particularly, to a power transmission assembly for an agricultural machine.

### BACKGROUND OF THE INVENTION

One form of an agricultural machine is an agricultural combine. Agricultural combines are engine powered machines that harvest, thresh, separate and clean an agricultural crop, such as for example, corn, soybeans, wheat, etc. An agricultural combine typically includes a transmission device to transfer rotary motion of the engine to various components, such as for example, to a feederhouse drive. One such feeder house drive includes a belt driven assembly that provides for variable rotational speeds of the driven shaft to which the drive is attached.

One type of drive uses woodruff keys, roll pins, and/or a thread adhesive in order to secure the drive to the driven shaft. However, in some applications, such attachment methods may not be adequate. Also, such drives may have problems with grease retention, resulting in the premature failure of the drive.

### SUMMARY OF THE INVENTION

The invention, in one form thereof, is directed to a power transmission assembly for an agricultural machine. The power transmission assembly includes a gearbox having an input shaft extending along an axis. The input shaft includes a first shaft portion having a first outside diameter, a second shaft portion having a second outside diameter and a beveled shoulder intermediate of the first shaft portion and the second shaft portion. The second shaft portion has a plurality of perimetrical splines and has a threaded end. A torque sensing assembly has an axially fixed sheave, an axially movable sheave, a cam assembly interposed between the axially fixed sheave and the axially movable sheave, and a spring assembly coupling the axially movable sheave to the axially fixed sheave. The axially movable sheave is movable along the axis in relation to the axially fixed sheave. The axially fixed sheave includes a hub portion having a first bore having a first inside diameter and having interior splines formed therein to engage the perimetrical splines of the input shaft when the axially fixed sheave is installed over the input shaft along the axis. The hub portion has a tapered face extending increasingly outward from the inside diameter to engage the beveled shoulder of the input shaft. A nut is engaged with the threaded end of the input shaft, such that when tightened the nut forces the tapered face of the axially fixed sheave into engagement with the beveled shoulder of the input shaft.

The invention, in another form thereof, is directed to an agricultural machine. The agricultural machine includes an engine, and a gearbox having an input shaft extending along an axis. The input shaft includes a first shaft portion having a first outside diameter, a second shaft portion having a second outside diameter and a beveled shoulder intermediate of the first shaft portion and the second shaft portion. The second shaft portion has a plurality of perimetrical splines and has a threaded end. A torque sensing assembly is rotatably coupled to the engine via a belt-type drive system. The torque sensing assembly has an axially fixed sheave, an axially movable sheave, a cam assembly interposed between the axially fixed sheave and the axially movable sheave, and a spring assembly coupling the axially movable sheave to the axially fixed sheave. The axially movable sheave is movable along the axis in relation to the axially fixed sheave. The axially fixed sheave includes a hub portion having a first bore having a first inside diameter and having interior splines formed therein to engage the perimetrical splines of the input shaft when the axially fixed sheave is installed over the input shaft along the axis. The hub portion has a tapered face extending increasingly outward from the inside diameter to engage the beveled shoulder of the input shaft. A nut is engaged with the threaded end of the input shaft, such that when tightened the nut forces the tapered face of the axially fixed sheave into engagement with the beveled shoulder of the input shaft.

The invention, in another form thereof, is directed to a power transmission assembly for an agricultural machine, including a gearbox and a torque sensing assembly. The gearbox has an input shaft extending along an axis. The torque sensing assembly is mounted to the input shaft. The torque sensing assembly has an axially fixed sheave, an axially movable sheave, a cam assembly interposed between the axially fixed sheave and the axially movable sheave, and a spring assembly coupling the axially movable sheave to the axially fixed sheave. The axially movable sheave is movable along the axis in relation to the axially fixed sheave. The axially fixed sheave includes a hub portion configured to engage the input shaft when the axially fixed sheave is installed over the input shaft along the axis. The cam assembly includes an inner cam and an outer cam, with a grease chamber being defined between the axially fixed sheave and the axially movable sheave, and between the inner cam and the outer cam. A vent path is formed in the hub portion of the axially fixed sheave from the grease chamber to the atmosphere.

### BRIEF DESCRIPTION OF THE DRAWINGS

FIG. 1 is a diagrammatic side view of an agricultural machine embodying the present invention.

FIG. 2 is a perspective end view of the power transmission assembly of the agricultural machine of FIG. 1.

FIG. 3 is a perspective side view, in partial section, of the power transmission assembly of FIG. 2.

FIG. 4 is an enlarged portion of the torque sensing assembly of the power transmission assembly of FIG. 3.

### DETAILED DESCRIPTION OF THE INVENTION

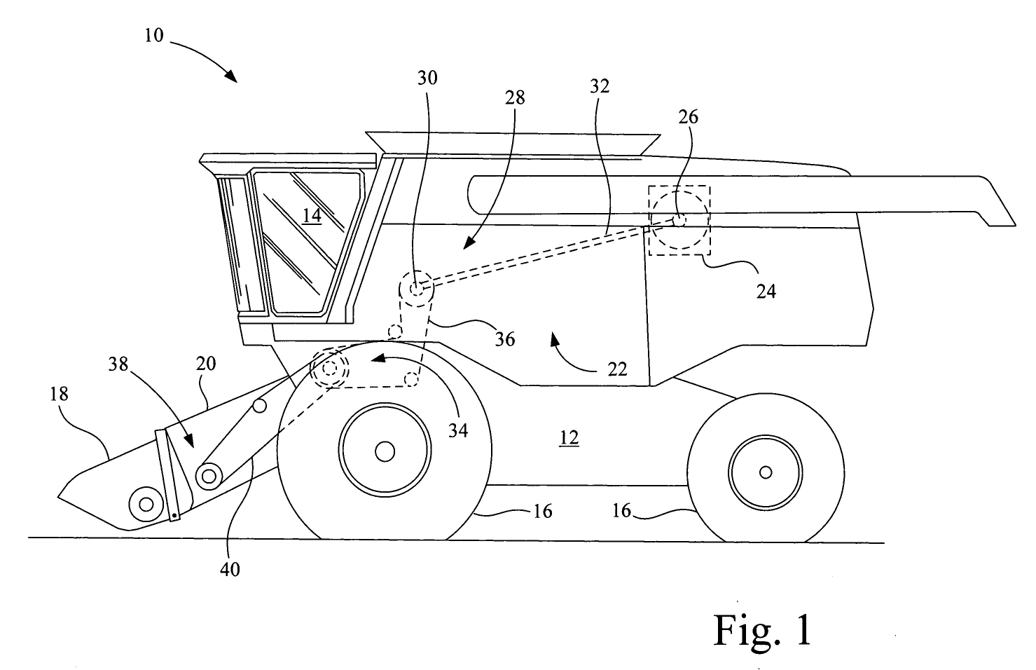

Referring now to the drawings, and more particularly to FIG. 1, there is shown an agricultural machine 10 in the form of a self-propelled combine. In the embodiment shown, agricultural machine 10 is in the form of a self-propelled agricultural combine. Although the invention is being described as being incorporated into a combine, it is contemplated that the present invention may be used with other types of agricultural machines.

Agricultural machine 10, in the form of a combine, includes a supporting structure 12. An elevated operator's station 14 is mounted at the front of agricultural machine 10. A propulsion unit 16, which may include tires and/or tracks that engage the ground, is coupled to supporting structure 12, and performs propulsion and/or steering functions. A harvesting platform 18 is used for harvesting a crop and directing the crop to a feederhouse 20. The harvested crop is directed by feederhouse 20 to a main separator body 22, which performs threshing, separating and cleaning operations.

A transversely oriented internal combustion engine 24 provides the mechanical power needed to perform the propulsion, harvesting, threshing, separating and cleaning operations. Engine 24 includes an output power shaft 26 coupled to a belt-type drive system 28. Belt-type drive system 28 includes a primary countershaft 30 connected to output power shaft 26 of engine 24 by a shaft and gearbox configuration 32, which is schematically illustrated. A variable speed assembly 34 is connected to the primary countershaft 30 by a drive belt 36. Variable speed assembly 34 is connected to a power transmission assembly 38 via a V-belt 40.

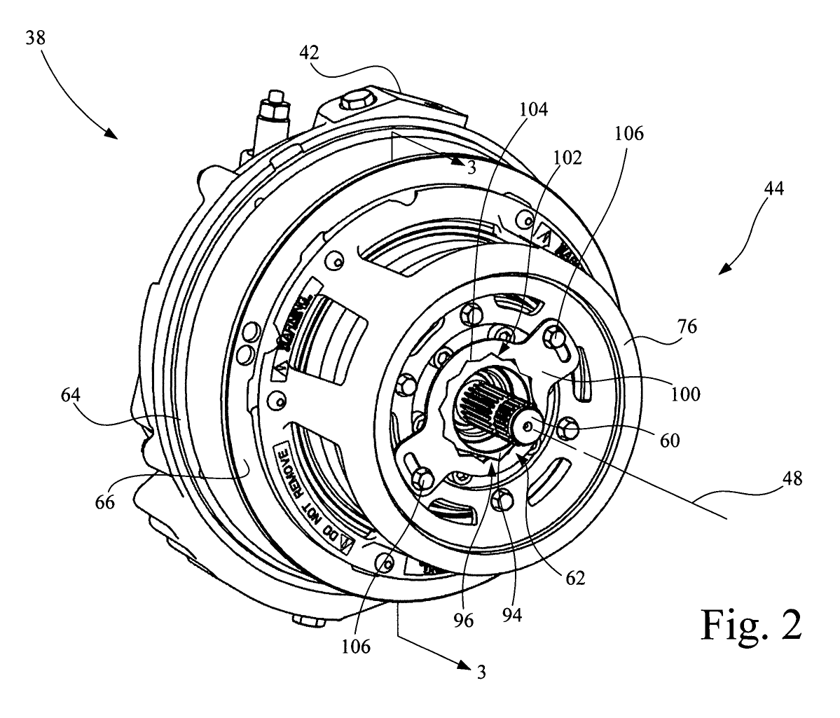

Referring to FIGS. 2-4, power transmission assembly 38, e.g., a feederhouse drive, includes a planetary gearbox 42 and a torque sensing assembly, e.g., sheave assembly, 44.

Planetary gearbox 42 includes an input shaft 46, e.g., a hollow driven shaft, having an axis 48. Input shaft 46 is a hub-like extension of an input sun gear (not shown) in planetary gearbox 42. Input shaft 46 of planetary gearbox 42 includes a first shaft portion 50 having an outside diameter D1, a second shaft portion 52 having an outside diameter D2 and a beveled shoulder 54 intermediate of first shaft portion 50 and second shaft portion 52. Diameter D2 is smaller than diameter D1. Second shaft portion 52 has a plurality of perimetrical splines 56 and has a threaded end 58. Perimetrical splines 56 are oriented parallel to axis 48, and have an overall diameter corresponding to diameter D2. A drive shaft 60 extends outwardly through input shaft 46 and includes a splined end 62 for coupling to a variable length header drive shaft (not shown) for driving harvesting platform 18.

Torque sensing assembly 44 is carried on input shaft 46 of planetary gearbox 42, and is mounted to input shaft 46 for rotation therewith. Torque sensing assembly 44, driven by the V-belt 40, is of the variable effective diameter torque-sensing or torque responsive type, and includes an axially fixed sheave 64 and an axially movable sheave 66 that is movable in relation to axially fixed sheave 64 along axis 48. Axially fixed sheave 64 has an inner belt engaging surface 68, and axially movable sheave 66 has an outer belt engaging surface 70.

A spring assembly 72 couples axially movable sheave 66 to axially fixed sheave 64. Spring assembly 72 includes a compression spring 74 carried between a spring retainer 76 and axially movable sheave 66, which biases axially movable sheave 66 axially along axis 48 towards axially fixed sheave 64 in the direction of increasing effective belt engaging diameter of sheave halves 64, 66.

Axially fixed sheave 64 includes a hub portion 78 having a proximal end 80 and a distal end 82. Hub portion 78 has a first bore 84 having of an inside diameter D3 with interior splines 86 formed therein to engage perimetrical splines 56 of input shaft 46 when axially fixed sheave 64 is installed over input shaft 46 along axis 48. The engagement of interior splines 86 of axially fixed sheave 64 with perimetrical splines 56 of input shaft 46 transfers the rotary motion of torque sensing assembly 44 to input shaft 46. Hub portion 78 has an annular tapered face 88 extending increasingly outward from inside diameter D3 to engage beveled shoulder 54 of input shaft 46. Distal end 82 of hub portion 78 of axially fixed sheave 64 includes a second bore 90 with an inside diameter D4 larger than diameter D3 of first bore 84 to form an internal annular ledge 92 extending from first bore 84 to second bore 90.

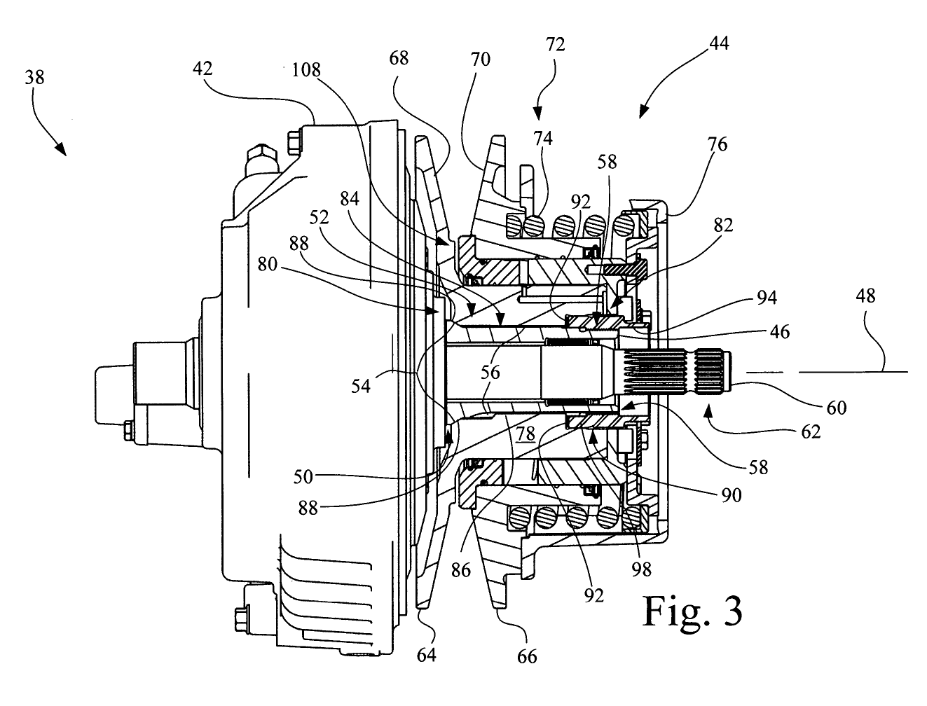

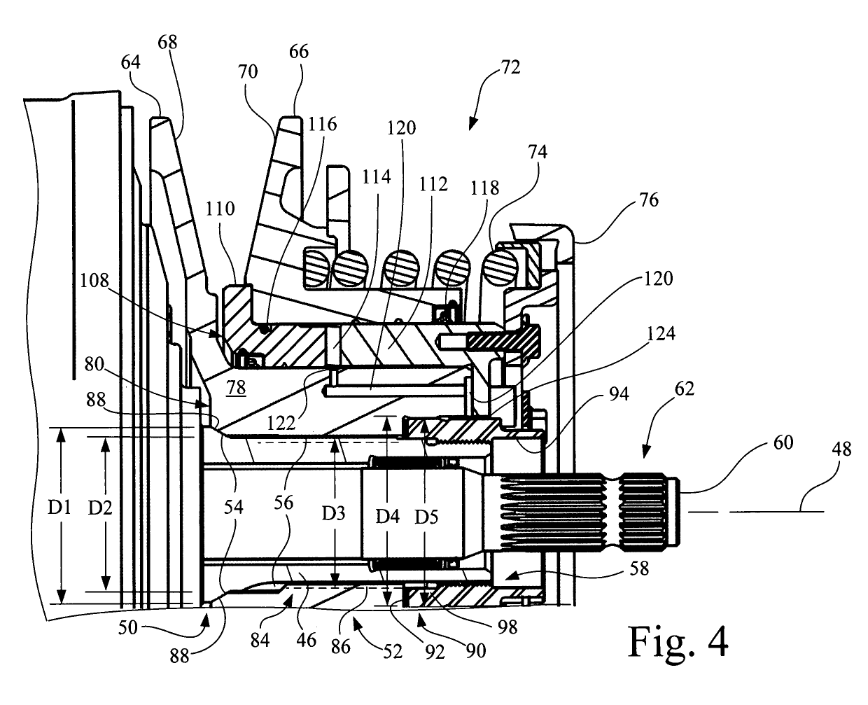

As shown in FIGS. 3 and 4, a single nut 94 and annular beveled shoulder 54 of input shaft 46 provide axial containment of torque sensing assembly 44 along axis 48 on input shaft 46. As best shown in FIG. 2, nut 94 has a plurality of surfaces 96, e.g., six, as a hex-nut, arranged in a polygonal pattern. Nut 94 engages threaded end 58 of input shaft 46, such that when tightened, nut 94 forces tapered face 88 of axially fixed sheave 64 into engagement with beveled shoulder 54 of input shaft 46. Nut 94 includes a cylindrical portion 98 sized with an outside diameter D5 intermediate inside diameter D3 of first bore 84 and inside diameter D4 of second bore 90. Cylindrical portion 98 is received in second bore 90 to engage internal annular ledge 92 as nut 94 is tightened.

A locking plate 100 is provided to prevent nut 94 from loosing after being torqued to the desired tightness. Locking plate 100 has an opening 102 defined by a plurality of internal surfaces 104 for engaging at least two of the plurality of surfaces 96 of nut 94. The plurality of internal surfaces 104 may be arranged, for example, in a 12-point star pattern for selective engagement with the 6-point pattern of nut 94, depending on the rotational position of nut 94 around axis 48. Locking plate 100 is secured to torque sensing assembly 44 by at least one fastener 106.

The torque-sensing or torque responsiveness of torque sensing assembly 44 depends upon control of relative rotation between the two sheave halves 64 and 66, and is effected by a cam assembly 108 annularly contained between axially fixed sheave 64 and axially movable sheave 66. Thus, cam assembly 108 is interposed between axially fixed sheave 64 and axially movable sheave 66. Cam assembly 108 includes an inner cam 110 and an outer cam 112, and is so disposed between axially fixed sheave 64 and axially movable sheave 66 that any tendency for relative rotation between the sheave halves 64, 66 results in a cam action that biases axially movable sheave 66 toward axially fixed sheave 64.

As best shown in FIG. 4, a grease chamber 114 is defined between axially fixed sheave 64 and axially movable sheave 66, and between inner cam 110 and outer cam 112. Accordingly, grease chamber 114 is generally bounded by axially fixed sheave 64, axially movable sheave 66, inner cam 110 and outer cam 112. A pair of seals, including a first seal 116 and a second seal 118, aid in preventing grease from escaping from grease chamber 114. Each of the seals 116 and 118 may be, for example, a double lip grease seal, or, as one alternative, one or more O-rings. First seal 116 is interposed between axially movable sheave 66 and inner cam 110 to prevent grease from escaping grease chamber 114 and contacting inner belt engaging surface 68 of axially fixed sheave 64 and outer belt engaging surface 70 of axially movable sheave 66. Second seal 118 is interposed between axially movable sheave 66 and outer cam 112.

A vent path 120 is formed in hub portion 78 of axially fixed sheave 64. Vent path 120 extends from a vent opening 122 adjacent grease chamber 114 to a vent opening 124 adjacent the atmosphere. Since vent opening 122 of vent path 120 is located closer to axis 48 than grease chamber 114, the centrifugal force associated with the rotation of torque sensing assembly 44 around axis 48 tends to force the grease in grease chamber 114 away from vent opening 122 of vent path 120, thereby aiding in keeping vent path 120 open to the atmosphere.

Having described the preferred embodiment, it will become apparent that various modifications can be made without departing from the scope of the invention as defined in the accompanying claims.

1. A power transmission assembly for an agricultural machine, comprising:
a gearbox having an input shaft extending along an axis, said input shaft including a first shaft portion having a first outside diameter, a second shaft portion having a second outside diameter and a beveled shoulder intermediate of said first shaft portion and said second shaft portion, said second shaft portion having a plurality of perimetrical splines and having a threaded end; and
a torque sensing assembly having an axially fixed sheave, an axially movable sheave, a cam assembly interposed between said axially fixed sheave and said axially movable sheave, and a spring assembly coupling said axially movable sheave to said axially fixed sheave, said axially movable sheave being movable along said axis in relation to said axially fixed sheave,
said axially fixed sheave including a hub portion having a first bore having a first inside diameter and having interior splines formed therein to engage said perimetrical splines of said input shaft when said axially fixed sheave is installed over said input shaft along said axis, said hub portion having a tapered face extending increasingly outward from said inside diameter to engage said beveled shoulder of said input shaft; and
a nut engaged with said threaded end of said input shaft, such that when tightened said nut forces said tapered face of said axially fixed sheave into engagement with said beveled shoulder of said input shaft.

2. The power transmission assembly of claim 1, wherein:
a distal end of said hub portion of said axially fixed sheave includes a second bore having a second inside diameter larger than said first inside diameter of said first bore to form an internal annular ledge extending from said first bore to said second bore; and
said nut includes a cylindrical portion sized with a third outside diameter intermediate said first inside diameter of said first bore and said second inside diameter of said second bore, said cylindrical portion being receive in said second bore to engage said internal ledge as said nut is tightened.

3. The power transmission assembly of claim 1, said nut having a plurality of surfaces arranged in a polygonal pattern, and further comprising a locking plate having an opening defined by at least two internal surfaces for engaging at least two of said plurality of surfaces of said nut, said locking plate being secured to said torque sensing assembly by at least one fastener.

4. The power transmission assembly of claim 3, wherein said at least two internal surfaces include a plurality of internal surfaces arranged in a star pattern configuration.

5. The power transmission assembly of claim 1, wherein said cam assembly includes an inner cam and an outer cam, with a grease chamber being defined between said axially fixed sheave and said axially movable sheave, and between said inner cam and said outer cam, and further comprising a vent path formed in said hub portion of said axially fixed sheave from said grease chamber to the atmosphere.

6. The power transmission assembly of claim 1, wherein said cam assembly includes an inner cam and an outer cam, with a grease chamber being defined between said axially fixed sheave and said axially movable sheave, and between said inner cam and said outer cam, and further comprising a first seal interposed between said axially movable sheave and said inner cam to prevent grease from escaping said grease chamber and contacting an inner belt engaging surface of said axially fixed sheave and an outer belt engaging surface of said axially movable sheave.

7. The power transmission assembly of claim 1, wherein said cam assembly includes an inner cam and an outer cam, and further comprising a first seal interposed between said axially movable sheave and said inner cam and a second seal interposed between said axially movable sheave and said outer cam.

8. An agricultural machine, comprising:
an engine;
a gearbox having an input shaft extending along an axis, said input shaft including a first shaft portion having a first outside diameter, a second shaft portion having a second outside diameter and a beveled shoulder intermediate of said first shaft portion and said second shaft portion, said second shaft portion having a plurality of perimetrical splines and having a threaded end; and
a torque sensing assembly rotatably coupled to said engine via a belt-type drive system, said torque sensing assembly having an axially fixed sheave, an axially movable sheave, a cam assembly interposed between said axially fixed sheave and said axially movable sheave, and a spring assembly coupling said axially movable sheave to said axially fixed sheave, said axially movable sheave being movable along said axis in relation to said axially fixed sheave,
said axially fixed sheave including a hub portion having a first bore having a first inside diameter and with interior splines formed therein to engage said perimetrical splines of said input shaft when said axially fixed sheave is installed over said input shaft along said axis, said hub portion having a tapered face extending increasingly outward from said inside diameter to engage said beveled shoulder of said input shaft; and
a nut engaged with said threaded end of said input shaft, such that when tightened said nut forces said tapered face of said axially fixed sheave into engagement with said beveled shoulder of said input shaft.

9. The agricultural machine of claim 8, wherein:
a distal end of said hub portion of said axially fixed sheave includes a second bore having a second inside diameter larger than said first inside diameter of said first bore to form an internal annular ledge extending from said first bore to said second bore; and
said nut includes a cylindrical portion sized with a third outside diameter intermediate said first inside diameter of said first bore and said second inside diameter of said second bore, said cylindrical portion being receive in said second bore to engage said internal ledge as said nut is tightened.

10. The agricultural machine of claim 8, said nut having a plurality of surfaces arranged in a polygonal pattern, and further comprising a locking plate having an opening defined by at least two internal surfaces for engaging at least two of said plurality of surfaces of said nut, said locking plate being secured to said torque sensing assembly by at least one fastener.

11. The agricultural machine of claim 10, wherein said at least two internal surfaces include a plurality of internal surfaces arranged in a star pattern configuration.

12. The agricultural machine of claim 8, wherein said cam assembly includes an inner cam and an outer cam, with a grease chamber being defined between said axially fixed sheave and said axially movable sheave, and between said inner cam and said outer cam, and further comprising a vent path formed in said hub portion of said axially fixed sheave from said grease chamber to the atmosphere.

13. The agricultural machine of claim 8, wherein said cam assembly includes an inner cam and an outer cam, with a grease chamber being defined between said axially fixed sheave and said axially movable sheave, and between said inner cam and said outer cam, and further comprising a first seal interposed between said axially movable sheave and said inner cam to prevent grease from escaping said grease chamber and contacting an inner belt engaging surface of said axially fixed sheave and an outer belt engaging surface of said axially movable sheave.

14. The agricultural machine of claim 8, wherein said cam assembly includes an inner cam and an outer cam, and further comprising a first seal interposed between said axially movable sheave and said inner cam and a second seal interposed between said axially movable sheave and said outer cam.

15. A power transmission assembly for an agricultural machine, comprising:
a gearbox having an input shaft extending along an axis; and
a torque sensing assembly mounted to said input shaft, said torque sensing assembly having an axially fixed sheave, an axially movable sheave, a cam assembly interposed between said axially fixed sheave and said axially movable sheave, and a spring assembly coupling said axially movable sheave to said axially fixed sheave, said axially movable sheave being movable along said axis in relation to said axially fixed sheave,
said axially fixed sheave including a hub portion configured to engage said input shaft when said axially fixed sheave is installed over said input shaft along said axis,
said cam assembly including an inner cam and an outer cam, with a grease chamber being defined between said axially fixed sheave and said axially movable sheave, and between said inner cam and said outer cam; and
a vent path formed in said hub portion of said axially fixed sheave from said grease chamber to the atmosphere.

16. The power transmission assembly of claim 15, further comprising a seal interposed between said axially movable sheave and said inner cam to prevent grease from escaping said grease chamber and contacting an inner belt engaging surface of said axially fixed sheave and an outer belt engaging surface of said axially movable sheave.

17. The power transmission assembly of claim 15, further comprising a first seal interposed between said axially movable sheave and said inner cam and a second seal interposed between said axially movable sheave and said outer cam.
